(19) United States
(12) Patent Application Publication
(10) Pub. No.: US 2007/0260754 A1
(43) Pub. Date: Nov. 8, 2007

(54) Hardware Assisted Exception for Software Miss Handling of an I/O Address Translation Cache Miss

(76) Inventors: John D. Irish, Rochester, MN (US); Chad B. McBride, Rochester, MN (US); Andrew H. Wottreng, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/279,614

(22) Filed: Apr. 13, 2006

(51) Int. Cl. G06F 3/00

(52) U.S. Cl. 710/3

(57) ABSTRACT

Embodiments of the present invention generally provide an improved technique to handle I/O address translation cache misses caused by I/O commands within a CPU. For some embodiments, CPU hardware may buffer I/O commands that cause an I/O address translation cache miss in a command queue until the I/O address translation cache is updated with the necessary information. When the I/O address translation cache has been updated, the CPU may reissue the I/O command from the command queue, translate the address of the I/O command at a convenient time, and execute the command as if a cache miss did not occur. This way the I/O device does not need to handle an error response from the CPU, the I/O command is handled by the CPU, and the I/O command is not discarded.

### BACKGROUND OF THE INVENTION

1. Field of the Invention

The present invention generally relates to I/O address translation within a central processing unit.

2. Description of the Related Art

Computing systems often include central processing units (CPUs). Often requests to execute commands are made to the CPU from other devices within a system. Examples of devices which may make a command request to a CPU include a video card, sound card, or an I/O (Input/Output) device within a system. An I/O device may send a command to the CPU for processing. The command from the I/O device may target a memory address, and reference that memory address by an I/O virtual memory address. If the command refers to a I/O virtual memory address, the CPU must translate the I/O virtual memory address to a corresponding physical memory address before executing the command.

To provide for faster access to data and instructions, as well as better utilization of the CPU, the CPU may have several caches. A cache is a memory which is typically smaller than the main memory of the computer system and is typically manufactured on the same die (i.e., chip) as the processor. Cache memory typically stores duplications of data from frequently used main memory locations. Caches may also store I/O virtual memory I/O address translation information such as segment tables and page tables to aid in the translation of I/O virtual memory addresses to corresponding physical memory addresses. Collectively, cache structures used to provide I/O address translation are commonly referred to as an I/O address translation cache or a translation lookaside buffer.

When a processor wishes to translate a memory address, the processor may check the I/O address translation cache first to see if the I/O address translation table entry is present in the cache. If so, the processor uses the I/O address translation table entry in the cache. If the I/O address translation table entry is present in the cache it is commonly referred to as a “cache hit”. If the I/O address translation table entry is not present in the cache it is commonly referred to as a “cache miss.” When a cache miss occurs, the desired data must be fetched from main memory.

Currently, when an I/O command that needs I/O address translation causes a cache miss, an interrupt may be generated within the CPU. This interrupt causes software executing on the CPU to perform some function in response to the I/O address translation cache miss. Often, the CPU and/or software will send an error response to the I/O device which sent the command needing I/O address translation. The I/O device must then determine what action to take in response to the error response. The I/O device may decide to re-issue the command, I/O device software may decide to restart an I/O operation, or I/O device software may commence a recovery operation.

A problem with this solution is the amount of time that it would take for software to handle the exception and indicate to the I/O device that the translation table entry has been loaded and that the command can be re-issued. Another problem with this solution is that there may be multiple commands from the I/O device being handled by the CPU when the I/O address translation miss occurs. When the processor tells the I/O device that it may re-issue the command which caused the I/O address translation cache miss, many of the other commands from the I/O device may have completed. This may cause ordering problems with the command which caused the I/O address translation cache miss.

Therefore, there is a need for an improved method and apparatus for handling an I/O address translation cache miss caused by a command received from an I/O device.

### SUMMARY OF THE INVENTION

The present invention generally provides systems and methods enabling software to handle an I/O address translation cache miss caused by a command received from an I/O device.

One embodiment provides a method for handling I/O address translation cache misses caused by one or more I/O commands sent to a central processing unit by one or more I/O devices. The method generally comprises: buffering the one or more I/O commands in a command queue within the central processing unit (CPU); fetching I/O address translation table entry from memory and placing the I/O address translation table entry in the I/O address translation cache; and doing at least one of reissuing the one or more I/O commands for I/O address translation or sending an error message to the one or more I/O devices which sent the one or more I/O commands to the CPU.

Another embodiment provides a central processing unit (CPU). The CPU generally comprising: an I/O address translation cache; one or more exception command queues; and command processing logic. The command processing logic is generally configured to buffer one or more I/O commands which caused a miss in the I/O address translation cache in the one or more exception command queues, under software control load the I/O address translation cache, and do at least one of: reissue the one or more I/O commands for I/O address translation or send an error message to one or more I/O devices which sent the one or more I/O commands to the CPU.

Another embodiment provides a system generally comprising: one or more Input/Output (I/O) devices; and a central processing unit (CPU). The CPU generally comprises: one or more exception command queues, an I/O address translation cache and, command processing logic. The command processing logic is generally configured to buffer in the one or more exception command queues one or more I/O commands which cause a miss in the I/O address translation cache; under software control load the I/O address translation cache; and do at least one of reissue the one or more I/O commands for I/O address translation, or send an error message to the one or more I/O devices which sent the one or more I/O commands to the CPU.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a computing environment, according to one embodiment of the invention.

FIG. 2 is a flowchart illustrating operations relating to receiving I/O device commands and performing I/O address translation, according to one embodiment of the invention.

FIGS. 3A and 3B are flowcharts illustrating operations relating to receiving I/O device commands and performing I/O address translation, according to one embodiment of the invention.

### DETAILED DESCRIPTION OF THE PREFERRED EMBODIMENTS

Embodiments of the present invention generally provide an improved technique to handle I/O address translation cache misses caused by I/O commands within a CPU. For some embodiments, CPU hardware may buffer I/O commands that cause an I/O address translation cache miss in a command queue until the I/O address translation cache is updated with the necessary information. When the I/O address translation cache has been updated, the CPU may reissue the I/O command from the command queue, translate the address of the I/O command at a convenient time, and execute the command as if a cache miss did not occur. This way the I/O device does not need to handle an error response from the CPU, the I/O command is handled by the CPU, and the I/O command is not discarded.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

### An Exemplary System

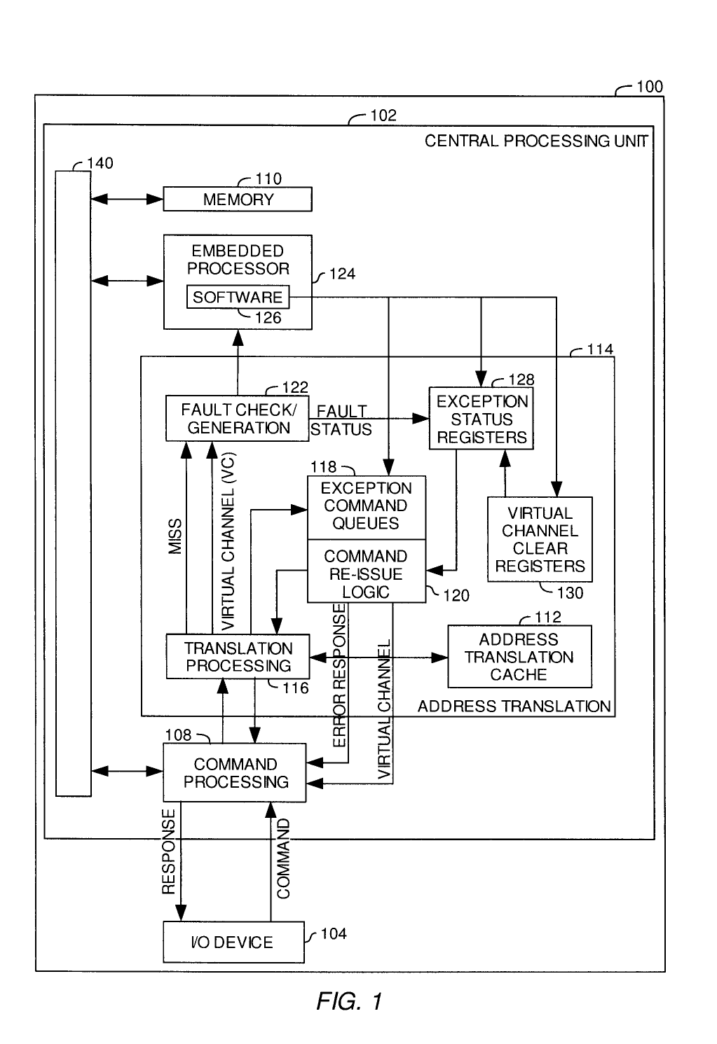

FIG. 1 is a block diagram illustrating a central processing unit (CPU) 102 coupled to an I/O device 104, according to one embodiment of the invention. In one embodiment, the CPU 102 may reside within a computer system 100 such as a personal computer or gaming system. The I/O device 104 may also reside within the same computer system. In a modern computing system there may be a plurality of I/O devices 104 attached to the CPU 102. For example, an I/O device 104 may consist of a sound card, a video card, or a keyboard. The I/O device 104 may be physically attached to the CPU 102 inside of the computing system by means of a bus.

An I/O device 104 will send commands to the CPU for execution. The CPU may respond to the I/O device 104 with a result. In one embodiment, a command processing system 108 may reside within the CPU 102. Within the command processing system commands sent from I/O devices 104 are stored and prepared for execution by the CPU 102.

A CPU 102 may also contain I/O address translation logic 114 to aid in the translation of a command's I/O virtual memory address to a physical memory address. The I/O address translation logic 114 may contain translation processing logic 116 and an I/O address translation cache 112 to facilitate I/O address translation. The I/O address translation logic 114 may also contain logic to perform operations related to handling I/O address translation cache misses. This logic may include but is not limited to: fault check and generation logic 122; exception command queues 118; command re-issue logic 120; exception status registers 128; and virtual channel clear registers 130.

The CPU 102 may also contain an embedded processor 124 for executing commands ready for processing, memory 110, and an on-chip data bus 140. The embedded processor 124 may be executing software 126.

### Exemplary Operations

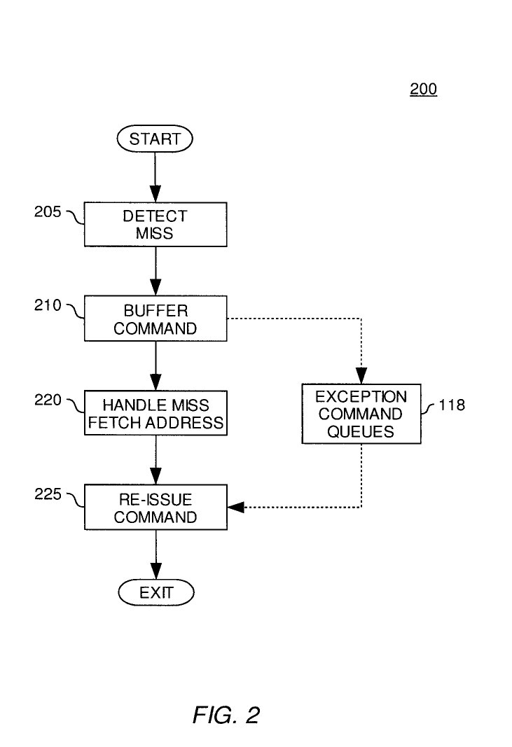

FIG. 2 is a flow chart illustrating a method 200 of performing I/O address translation, according to one embodiment of the invention. The method 200 may begin at step 205 where the CPU 102 detects a cache miss due to a command sent by an I/O device. The cache miss may be detected by the translation processing logic 116 after the I/O virtual memory address of an I/O command is presented to the I/O address translation cache 112. If the I/O virtual memory address of the I/O command is not in the I/O address translation cache 112, then a cache miss will occur. After the cache miss has occurred at step 205 the translation processing logic 116 may place the command into a buffer as seen at step 210. This buffer may consist of several exception command queues 118, which may organize commands according to the I/O device which sent the command. Logic may organize the commands according to an IOID (Input/Output Identification) and/or the virtual channel corresponding to the I/O device which sent the cache miss causing command.

Logic within the CPU 102 which detected the cache miss may also notify software or other hardware within the CPU 102 that a cache miss has occurred. The notification of a cache miss may occur by generating an exception within the CPU 102. After the command has been placed in a buffer or an exception command queue 118, the translation processing logic 116 may continue to translate addresses for other commands received from I/O devices. Meanwhile, at step 220, in response to the exception, software executing on the embedded processor 124 or other logic within CPU 102 may perform processes to fetch the physical memory address needed to translate the I/O virtual memory address of the command which caused the cache miss. After the physical memory address for the command has been fetched from memory, the physical memory address may be placed in the I/O address translation cache 112. Once the physical memory address is in the I/O address translation cache 112, the command may be reissued, at step 225, from the exception command queue into the translation processing logic 116. The translation processing logic may now perform operations to translate the I/O virtual memory address of the I/O command into the corresponding physical memory address.

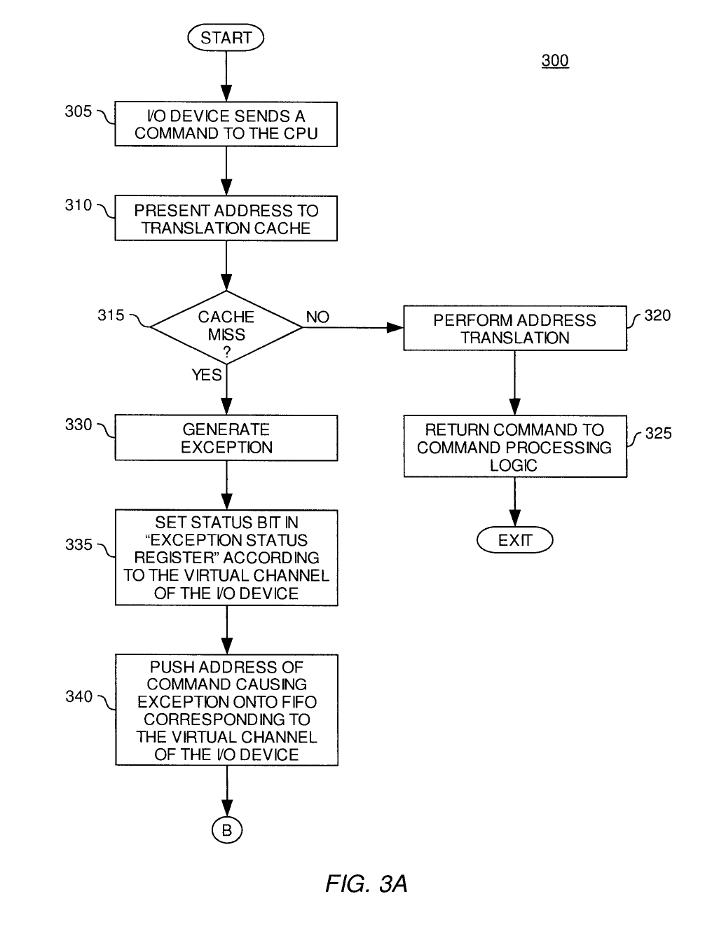

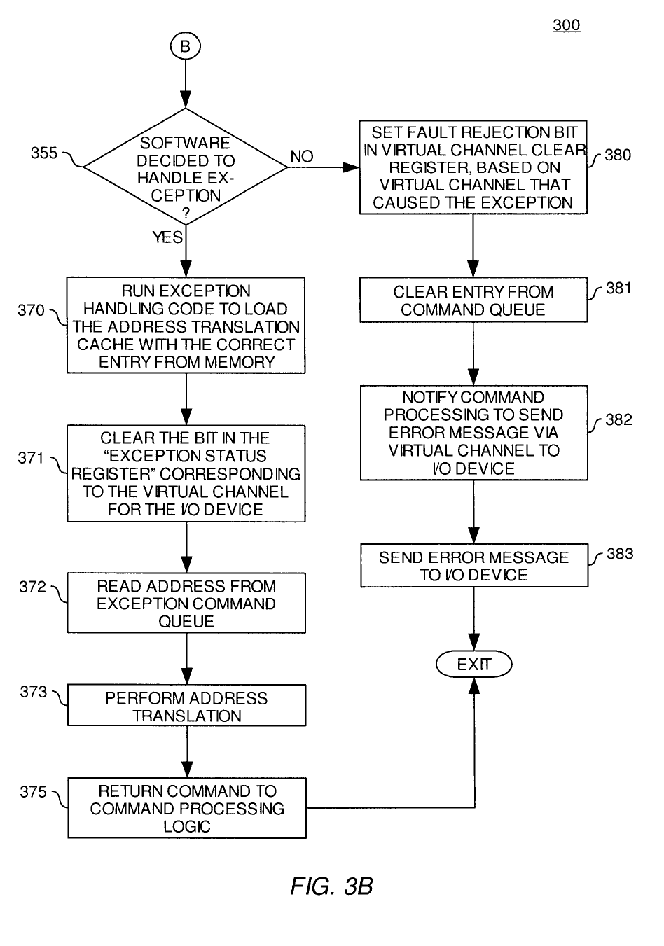

FIGS. 3A and 3B illustrate a more detailed method 300 of performing I/O address translation than described in regards to method 200 of FIG. 2. FIG. 3A is a flowchart illustrating a method 300 of performing I/O address translation, according to one embodiment of the invention. The method 300 begins at step 305 when an I/O device 104 sends a command to the CPU 102. This command may be any command sent by an I/O device 104 to the CPU 102 for processing. For example, the command may be a load from memory command or a store to memory command.

Next, at step 310, the translation processing logic 116 may present the I/O virtual memory address for the I/O command to the I/O address translation cache 112 to determine if the corresponding physical memory address is present in the I/O address translation cache 112. If so, the translation processing logic 116 may perform operations relating to I/O address translation at step 325. These operations may include replacing the I/O virtual memory address of the command with the corresponding physical memory address present in the I/O address translation cache 112. Next, at step 325, the command may be returned to the command processing logic 108. After the command processing logic 108 receives the command, it may be issued onto the on-chip bus 140 for further processing.

However, if the physical memory address corresponding to the I/O virtual memory address was not present in the I/O address translation cache 112 (i.e., a cache miss), operations may be performed at step 330 to alert the embedded processor 124 of the cache miss.

In one embodiment of the invention, the embedded processor may be alerted of the cache miss through the use of fault check and generation logic 122. If an I/O address translation cache miss has occurred, the translation processing logic 116 may generate an exception indicating to the processor 124 that an I/O address translation cache miss has occurred. Next, at step 335, the fault check and generation logic 122 may set a status bit in the exception status register 128 corresponding to the virtual channel (i.e., the I/O device) which sent the command that caused the cache miss.

The translation processing logic 116 may then push the I/O command which caused the cache miss into an exception command queue 118 at step 340. The exception command queue 118 may be a first-in-first-out command queue, according to one embodiment of the invention. The exception command queue 118 may hold many I/O commands which caused I/O address translation cache misses, and assigns them to a queue based on the virtual channel from which the command was sent. Each virtual channel exception command queue may also hold subsequent commands from the same virtual channel. This is done to ensure that commands from the same virtual channel are performed in order while allowing subsequent commands from different virtual channels to proceed.

Software 126 executing on the embedded processor 124 may respond to the exception generated by the fault check and generation logic 122 by executing exception handling code. Referring now to FIG. 3B, at step 355, the software 126 may determine if operations should be performed in relation to the exception generated by the fault check and generation logic 122. If so, software may run the appropriate exception handling code at step 370. At step 370, software 126 may perform a plurality of actions to load the correct information into the I/O address translation cache 112. For example, software may directly load the correct I/O address translation table entry or entries into I/O address translation cache 112 through a series of writes.

Once the I/O address translation cache 112 has been loaded with the correct I/O address translation table entry for the I/O command which caused the I/O address translation cache 112 miss, software may clear the bit in the exception status register 128 corresponding to the I/O command's virtual channel by writing to a virtual channel clear register 130 at step 371. Writing to the virtual channel clear register 130 may also indicate to the command re-issue logic 120 that the command waiting in the exception command queue 118 may be ready for I/O address translation. Therefore, at step 372, the command re-issue logic 120 may notify the translation processing logic 116, which in turn reads the command, the command corresponding to the virtual channel written to in step 371, from the exception command queue 118.

After the command is read into the translation processing logic 116 at step 373, the translation processing logic 116 may again perform operations relating to I/O address translation (step 373). These operations may include presenting the I/O virtual memory address of the I/O command to the I/O address translation cache 112 to determine the corresponding physical memory address for the command. Due to the operations performed by software 126 in step 370, the physical memory address should now be present in the I/O address translation cache 112. The I/O address translation operations may also include replacing the I/O virtual memory address of the command with the corresponding physical memory address present in the I/O address translation cache 112. Next, at step 375, the command now containing the physical memory address may be returned to the command processing logic 108. After the command processing logic 108 receives the command, it may be issued onto the on-chip bus 140 for further processing.

Returning to step 355, if software 126 decides that operations should not be performed to handle the exception generated by the fault check and generation logic 122, software may set a fault rejection bit in the virtual channel clear register 130 corresponding to the virtual channel for the I/O device that sent the command (step 380). Setting the fault rejection bit in the virtual channel clear register 130 may commence a plurality of actions. The fault rejection bit may cause the command re-issue logic 120 to drop the corresponding command entry from the exception command queue 118 at step 381. Setting the fault rejection bit in step 380 may also send a signal (step 382) to the command processing logic 108. This signal may indicate to the command processing logic 108 that it may send an error message to the I/O device which initially sent the I/O command that caused the I/O address translation cache miss (step 383). Setting the fault rejection bit in the virtual channel clear register 130 may also clear the corresponding virtual channel bit in the exception status register 128.

### CONCLUSION

Embodiments of the present invention provide improved techniques to handle an I/O address translation cache miss caused by an I/O command. For some embodiments, a CPU may buffer I/O commands which cause an I/O address translation cache miss inside the CPU. While the command is buffered by the CPU, software may fetch the previously missing data from memory and place it in the I/O address translation cache. Once the data is in the I/O address translation cache the CPU may then translate the address of the buffered command. This way the CPU may provide I/O address translation without having to notify the I/O device an I/O address translation cache miss occurred.

While the foregoing is directed to embodiments of the present invention, other and further embodiments of the invention may be devised without departing from the basic scope thereof, and the scope thereof is determined by the claims that follow.

What is claimed is:

1. A method of handling I/O address translation cache misses caused by one or more I/O commands sent to a central processing unit by one or more I/O devices, comprising:
buffering the one or more I/O commands in one or more command queues within the central processing unit (CPU);
fetching at least one I/O address translation table entry from memory and placing the I/O address translation table entry in the I/O address translation cache; and
doing at least one of: reissuing the one or more I/O commands for I/O address translation, or sending an error message to the one or more I/O devices which sent the one or more I/O commands to the CPU.

2. The method of claim 1, further comprising generating an exception in the central processing unit when the one or more I/O commands cause an I/O address translation cache miss.

3. The method of claim 2, further comprising setting a bit in an exception status register corresponding to one or more virtual channels on which the one or more I/O commands were sent to the CPU when the one or more I/O commands causes an I/O address translation cache miss.

4. The method of claim 1, further comprising, in response to fetching the I/O address translation table entry, software clearing a bit in an exception status register.

5. The method of claim 4, further comprising, in response to software clearing a bit in an exception status register, doing at least one of: reissuing the one or more commands for I/O address translation, in response to software clearing an exception status bit, or sending an error message to the one or more devices which sent the I/O command to the central processing unit in response to software setting a fault rejection bit.

6. The method of claim 1, wherein fetching the I/O address translation table entry from memory and placing it in the I/O address translation cache is handled by software.

7. The method of claim 1, wherein the one or more command queues store one or more I/O commands corresponding to the same virtual channel on which the one or more I/O commands were sent to the central processing unit.

8. The method of claim 7, wherein the one or more I/O commands are reissued on a virtual channel basis.

9. The method of claim 7, wherein sending an error message to the one or more I/O devices which sent the one or more I/O commands to the CPU further comprises, dropping the one or more commands from the one or more command queues on a per virtual channel basis.

10. A central processing unit (CPU) comprising:
an I/O address translation cache;
one or more exception command queues; and
command processing logic configured to buffer one or more I/O commands which caused a miss in the I/O address translation cache in the one or more exception command queues, and after an exception, under software control, load the I/O address translation cache, and do at least one of: reissue the one or more I/O commands for I/O address translation or send an error message to one or more I/O devices which sent the one or more I/O commands to the CPU.

11. The CPU of claim 10, wherein the command processing logic is further configured to:
generate an exception in the CPU when the one or more I/O commands cause an I/O address translation cache miss and the command processing logic is configured for software to handle cache misses; and
set a bit in an exception status register corresponding to one or more virtual channels on which the one or more I/O commands were sent to the CPU when the one or more I/O commands caused a miss in the I/O address translation cache.

12. The CPU of claim 10, further comprising at least one of: an exception status register having bits which may be cleared by software, or a virtual channel clear register having fault rejection bits which may be set by software.

13. The CPU of claim 12, wherein:
the command processing logic buffers within the command queue one or more I/O commands corresponding to one or more virtual channels on which the one or more I/O commands were sent to the CPU; and
wherein the command processing logic is further configured to reissue the one or more I/O commands on a virtual channel basis in response to a cleared bit in the exception status register.

14. The CPU of claim 12, wherein:
in response to setting the fault rejection bit in the virtual channel clear register, the command processing logic is further configured to send an error message, on a virtual channel basis, to one or more I/O devices which sent the one or more I/O commands to the CPU, and drop one or more commands from the command queue corresponding to the I/O devices which sent the one or more commands to the CPU.

15. A system, comprising:
one or more Input/Output (I/O) devices;
and a central processing unit (CPU) wherein the CPU comprises:
one or more exception command queues,
an I/O address translation cache and,
command processing logic configured to:
buffer in the one or more exception command queues one or more I/O commands which cause a miss in the I/O address translation cache;
after an exception, under software control, load the I/O address translation cache; and
do at least one of: reissue the one or more I/O commands for I/O address translation, or send an error message to the one or more I/O devices which sent the one or more I/O commands to the CPU.

16. The system of claim 15, wherein the CPU is further configured to:
generate an exception in the central processing unit when the one or more I/O commands cause a miss in the I/O address translation cache and the command processing logic is configured for software to handle cache misses; and
set a bit in an exception status register corresponding to one or more virtual channels on which the one or more I/O commands were sent to the CPU when the one or more I/O commands cause a miss in the I/O address translation cache.

17. The system of claim 15, wherein the command processing logic buffers in the one or more exception command queues one or more I/O commands corresponding to one or more virtual channels on which the one or more I/O commands were sent to the CPU

18. The system of claim 15, wherein the CPU further comprises at least one of: an exception status register having bits which may be cleared by software, or a virtual channel clear register having fault rejection bits which may be set by software

19. The system of claim 18, wherein in response to clearing a bit in the exception status register, the command processing logic is further configured to reissue the one or more I/O commands on a virtual channel basis.

20. The system of claim 18, wherein in response to setting a fault rejection bit in a virtual channel clear register the command processing logic is further configured to drop one or more commands from the one or more command queues when the command processing logic sends an error message to the one or more I/O devices which sent the one or more I/O commands to the CPU.
